(19) United States
(12) Patent Application Publication
(10) Pub. No.: US 2018/0216577 A1
(43) Pub. Date: Aug. 2, 2018

(54) FUEL GAS SUPPLY DEVICE FOR PROVIDING A FUEL GAS, AND AN INTERNAL COMBUSTION ENGINE

(71) Applicant: MTU FRIEDRICHSHAFEN GMBH, Friedrichshafen (DE)

(72) Inventors: Manuel BOOG, Baindt (DE); Peter KUNZ, Nonnenhorn (DE)

(21) Appl. No.: 15/747,626

(22) PCT Filed: Jun. 28, 2016
(86) PCT No.: PCT/EP2016/001095

§ 371 Date: Jan. 25, 2018

(30) Foreign Application Priority Data
Jul. 27, 2015 (DE) 10 2015 214 191.8

(51) Int. Cl. F02M 21/02; F02M 21/06; F02M 31/02; F17C 7/04; F17C 13/04

(52) U.S. Cl. CPC F02M 21/0236; F17C 2250/0626; F02M 21/0221; F02M 21/0239; F02M 21/06; F02M 31/02; F17C 7/04; F17C 13/04; F17C 2221/033; F17C 2223/013; F17C 2225/0123; F17C 2227/0309; F17C 2227/0337; F17C 2227/039; F17C 2227/0393; F17C 2250/043; F02M 21/0209

(57) ABSTRACT

A fuel gas supply device for providing a fuel gas to a fuel gas supply point, including: a fuel gas reservoir that is configured to store liquid fuel gas, the fuel gas reservoir being fluidically connected to a first supply path and a second supply path, the first supply path and second supply path each including a heat exchanger configured to evaporate liquid fuel gas; and a valve device configured alternately to connect the first supply path to the fuel gas supply point and simultaneously block the second supply path or connect it to the fuel gas reservoir, and to connect the second supply path to the fuel gas supply point and simultaneously block the first supply path or connect it to the fuel gas reservoir.

The invention relates to a fuel gas supply device, and to an internal combustion engine having such a fuel gas supply device.

A fuel gas supply device which serves for providing a fuel gas for a consumer to a fuel gas supply point typically has a fuel gas reservoir which is set up for storing liquid fuel gas. Here, the fuel gas is present in particular in a cryogenic state and is thus liquefied. In order to be able to provide a sufficiently high supply pressure at the fuel gas supply point, either it is necessary to preload the fuel gas reservoir entirely to a correspondingly high pressure level, or a cryopump for compressing the cryogenic fuel gas has to be used. Preloading of the fuel gas reservoir to a high pressure is a problem for safety reasons, wherein a requisite amount of effort for ensuring sufficient safety increases with increasing tank size up to an unreasonable amount of effort in the case of very large tanks. Such large fuel gas reservoirs must then also be of very heavy and thus expensive design for strength reasons. Added to this is the problem that, in the case of an intense movement of the fuel gas reservoir, there is a risk of sloshing in the tank and a risk that the pressure level in the fuel gas reservoir drops. This is the case for example in marine applications, in particular if severe sea states prevail. Cryopumps are used in particular for relatively high supply pressures, typically greater than 4.5 bar absolute. A disadvantage with this is that such systems are very expensive, with the order of magnitude of the costs for such a cryopump system easily being in the region of the costs for an internal combustion engine which is to be supplied with fuel gas by means of the fuel gas supply device.

The invention is based on the object of providing a fuel gas supply device, and an internal combustion engine, in which the disadvantages mentioned do not occur.

The object is achieved by providing the subject matter of the independent claims. Advantageous configurations emerge from the dependent claims.

The object is achieved in particular by providing a fuel gas supply device which is set up for providing a fuel gas to a fuel gas supply point, wherein the fuel gas supply device comprises a fuel gas reservoir which is set up for storing liquid fuel gas, wherein the fuel gas reservoir is fluidically connected to a first supply path and to a second supply path. In this case, the first supply path and the second supply path each have a heat exchanger, in particular the first supply path has a first heat exchanger and the second supply path has a second heat exchanger, wherein each heat exchanger is set up for evaporating liquid fuel gas. The fuel gas supply device furthermore comprises a valve device which is set up to alternately a) connect the first supply path to the fuel gas supply point, and at the same time block the second supply path or connect it to the fuel gas reservoir, in a first operating state, and b) connect the second supply path to the fuel gas supply point, and at the same time block the first supply path or connect it to the fuel gas reservoir, in a second operating state. The fact that the supply paths are alternately connected, in particular at one time to the fuel gas supply point and at some other time to the fuel gas reservoir, in an alternating manner, or blocked means that it is possible to alternately generate in the supply paths a relatively high pressure—in particular by evaporation of the fuel gas in the respective heat exchanger—and then to supply the fuel gas, pre-pressurized in said manner, to the fuel gas supply point. Once the pressure level in a supply path is no longer sufficient, a switchover to the other supply path, in which an elevated fuel gas pressure has been generated in the intervening time by supplying fuel gas from the fuel gas reservoir and by evaporating the fuel gas in the heat exchanger, occurs. In this case, it is not necessary to preload the fuel gas reservoir itself to a pressure level which is sufficient for the fuel gas supply point, rather the fuel gas reservoir can have a lower pressure level, in particular a pressure level which is just sufficient for feeding the heat exchangers in the supply paths. This significantly reduces the security requirements and the effort in the design of the fuel gas reservoir, which in particular has a positive effect in the case of large fuel gas reservoirs and/or in marine applications. Furthermore, a cryopump may be dispensed with because the pressure required for the fuel gas supply point is able to be generated alternately in the supply paths by means of the heat exchangers.

Overall, a pump-free fuel gas supply system having a thermal pressure increasing device is thus provided, wherein both the pre-pressurizing and the delivery of the fuel gas ultimately occurs in a thermal manner via the heat exchangers.

Particularly preferably, the fuel gas supply device is free of a cryopump, and it thus preferably has no cryopump. In this way, the fuel gas supply device itself may be of low-cost and simple design.

A “fuel gas” is to be understood in particular as meaning a substance which under normal conditions, in particular therefore at 1013 mbar absolute and at 25° C., is gaseous and which is combustible. The fuel gas is preferably suitable for operating an internal combustion engine with the fuel gas as fuel. Particularly preferably, the fuel gas comprises methane or consists of methane. The fuel gas is preferably able to be liquefied by way of cooling and/or pressure elevation and, in this respect, able to be stored in a fuel gas reservoir as liquid fuel gas, in particular in a cryogenic fuel gas reservoir as cryogenic liquid fuel gas. Particularly preferably, the fuel gas is natural gas. Liquefied natural gas is also referred to as LNG. It is particularly suitable for storage in liquid form in a fuel gas reservoir and for the operation of internal combustion engines.

A “fuel gas supply point” is to be understood in particular as meaning a location of the fuel gas supply device at which the fuel gas is present at a pressure level intended for providing a supply to a consumer, and at which the fuel gas supply device is preferably fluidically connected to the consumer. The fuel gas supply point may be operatively connected to a gas regulating section of the consumer, wherein the fuel gas pressure at the fuel gas supply point then corresponds to an inlet pressure for the gas regulating section, wherein the actual consumption location of the consumer, for example a combustion chamber of an internal combustion engine, or an injector, is provided with a supply at a pressure level which is set by way of the gas regulating section and which is lower than that which prevails at the fuel gas supply point. The two supply paths are preferably fluidically connected to the same fuel gas supply point such that the fuel gas supply point is able to be supplied with fuel gas alternately by one supply path and by the other supply path.

The fuel gas supply device is set up in particular for providing the fuel gas to the fuel gas supply point above a first pressure level. Here, the fuel gas supply device is set up in particular to monitor that the pressure at the fuel gas supply point does not drop below the first pressure level. The first pressure level is preferably higher than a pressure in the fuel gas reservoir. The pressure increase is brought about by evaporation of the fuel gas in the heat exchangers.

“Blocking of a supply path” is to be understood in particular as meaning that said path is fluidically separated both from the fuel gas supply point and from the fuel gas reservoir. In this case, the supply path is preferably completely separated from its surroundings.

The fuel gas supply device is also preferably set up for separating the first supply path from the fuel gas reservoir when the first supply path is connected to the fuel gas supply point. It is furthermore preferably set up for separating the first supply path from the fuel gas supply point when said path is connected to the fuel gas reservoir. Analogously, precisely the same preferably applies to the second supply path.

Preference is given to an exemplary embodiment of the fuel gas supply device wherein the fuel gas reservoir has a first storage volume for liquid fuel gas, and has a second storage volume for gaseous fuel gas in particular as a pressure cushion for the first storage volume. This corresponds to a design of the fuel gas reservoir which is known per se, wherein the second storage volume can be preloaded with the aid of the pressure cushion. For this purpose, a pressure build-up device, which has in particular a pressure build-up evaporator, is preferably provided between the first storage volume and the second storage volume—in particular outside the fuel gas reservoir—such that, by means of the pressure build-up device, a pressure can be set in the pressure cushion by way of evaporation of fuel gas. Particularly preferably here, the pressure in the first storage volume and/or in the second storage volume is able to be regulated. The fuel gas reservoir can, in this way, be kept at a pressure which is predetermined and defined, in particular by the pressure cushion. In the fuel gas reservoir, the first storage volume and the second storage volume are preferably separated only by the phase boundary between the liquid fuel gas (liquid phase) and the gaseous fuel gas (gas phase).

The valve device is preferably set up such that, when one of the supply paths is connected to the fuel gas supply point, the other supply path, which is not connected to the fuel gas supply point, c) is connected by the device to the second storage volume d) is connected by the device to the first storage volume, and e) is blocked by the device. In this way, it is possible to connect that supply path which is not connected to the fuel gas supply point in particular firstly to the second storage volume in order to relieve the supply path of pressure toward the second storage volume and, in this respect, to allow flowing in of liquid fuel gas, then to connect said supply path to the first storage volume in order that liquid fuel gas can flow in from the first storage volume into the supply path, and finally to block the supply path—in particular specifically both with respect to the fuel gas supply point and with respect to the fuel gas reservoir in order, by means of the heat exchanger in the supply path, to evaporate the liquid fuel gas present in the heat exchanger and thus to increase the pressure in the supply path.

The other supply path, which is not connected to the fuel gas supply point, is thus preferably firstly connected to the second storage volume and thus relieved of pressure, then connected to the first storage volume and fed with liquid fuel gas, and then finally blocked, wherein the liquid fuel gas is evaporated in the supply path by the heat exchanger.

In this way, it is possible to provide in the supply path a fuel gas pressure which is elevated in comparison with the pressure level of the fuel gas reservoir. If the pressure level drops in the supply path, which is connected to the fuel gas supply point, and at the same time at the fuel gas supply point, to or below a specific level, said supply path can be separated from the fuel gas supply point, and the other supply path can be connected to the fuel gas supply point such that an elevated fuel gas pressure is again available for the provision of a supply to the fuel gas supply point. The one supply path, previously connected to the fuel gas supply point but now separated therefrom can now—as described for the other supply path—firstly be connected to the second storage volume, then connected to the first storage volume, and finally blocked. These steps can be carried out in an alternating manner in order to provide a sufficiently high pressure level at the fuel gas supply point alternative from the first and second supply path.

Overall, the valve device preferably has the following switching states: A first switching state in which the first supply path is fluidically connected to the first storage volume, wherein the second supply path is fluidically connected to the fuel gas supply point. In this case, liquid fuel gas flows from the first storage volume into the first supply path, and the fuel gas supply point is fed from the second supply path.

In a second switching state, the first supply path is blocked, and the second supply path continues to be fluidically connected to the fuel gas supply point. The fuel gas supply point therefore continues to be fed from the second supply path, and, in the first, blocked supply path, liquid fuel gas is evaporated and pressurized by means of the heat exchanger.

In a third switching state, the first supply path is fluidically connected to the fuel gas supply point, and the second supply path is fluidically connected to the second storage volume. In this case, the fuel gas supply point is now fed from the first supply path, and the second supply path is relieved of pressure toward the pressure cushion so that it has the same pressure level as the fuel gas reservoir, with the result that liquid fuel gas can flow from the fuel gas reservoir into the second supply path in a next step.

In a fourth switching state, the first supply path continues to be fluidically connected to the fuel gas supply point. At the same time, the second supply path is fluidically connected to the first storage volume. In this way, the fuel gas supply point is fed from the first supply path, and liquid fuel gas is able to flow from the first storage volume into the second supply path. In this case, there is in particular a flow into the heat exchanger of the latter.

In a fifth operating state, the fuel gas supply point continues to be fluidically connected to the first supply path and is fed therefrom, and the second supply path is blocked. Here, liquid fuel gas is evaporated and thus pressurized by means of the heat exchanger in the second supply path.

In a sixth switching state, the second supply path is finally fluidically connected to the fuel gas supply point again, and at the same time the first supply path is fluidically connected to the second storage volume such that it is relieved of pressure toward the pressure cushion.

The first switching state preferably follows the sixth switching state, and so a cyclic sequence of the six switching states described separately here is realized overall. It is clear that, in this case, the fuel gas supply point is supplied with highly pre-pressurized fuel gas from one of the two supply paths at all times in an alternating manner, wherein measures are implemented in the other supply path to build up the elevated pressure level again. Thus, neither a cryopump is required, nor is it necessary for the fuel gas reservoir itself to be kept at the pressure level intended for the fuel gas supply point.

According to a refinement of the invention, it is provided that the valve device has for each supply path in each case a first switching valve in a first fluidic connection between the first storage volume and the heat exchanger, and a second switching valve in a second fluidic connection between the heat exchanger and the fuel gas supply point. Here, the first fluidic connection extends from the first storage volume to an inlet of the heat exchanger. The second fluidic connection extends from an outlet of the heat exchanger to the fuel gas supply point. It is possible to fluidically connect the supply path either to the fuel gas reservoir or to the fuel gas supply point, or to block the supply path, by means of the switching valves, in that either in each case one of the two switching valves is opened and the other one is closed, or in that both switching valves are closed.

According to a refinement, it is provided that the valve device has for each supply path in each case a third switching valve in a third fluidic connection between the heat exchanger and the second storage volume. The third fluidic connection preferably extends from a mouth point out of the second fluidic connection, which is downstream of the outlet of the heat exchanger and upstream of the second switching valve, to a mouth into the second storage volume. It is consequently possible to relieve the supply path of pressure toward the second storage volume by means of the third switching valve, wherein said path is at the same time able to be separated both from the first storage volume and from the fuel gas supply point in that, specifically, the first switching valve and the second switching valve are closed, the third switching valve, however, being opened.

According to a refinement of the invention, it is provided that the fuel gas supply point, the first supply path and/or the second supply path is/are assigned in each case a buffer container. Particularly preferably, the first supply path is assigned a first buffer container. Alternatively or additionally, the second supply path is assigned a second buffer container. Alternatively or additionally, the fuel gas supply point is assigned a third buffer container. The at least one buffer container serves for storing pressurized fuel gas and providing a buffer volume, in particular in order to be able to maintain, or at least to allow a slow decrease of, a set pressure over a specific period of time. In this way, it is possible, in a manner dependent on the volumes of the buffer containers, for a frequency of switching between the different switching states to be determined, wherein the volume of the at least one buffer container determines in particular the length of time until the pressure level at the fuel gas supply point has decreased to the first pressure level, starting from an elevated pressure level set in one of the supply paths, in the case of a specific fuel gas outflow from the fuel gas supply point to a consumer.

The buffer containers assigned to the supply paths are preferably each arranged downstream of the heat exchanger and preferably upstream of the mouth of the third fluid path into the second fluid path. The third buffer container is preferably arranged downstream of a merging point of the supply paths in a common line section of the fuel gas supply point.

According to a refinement of the invention, it is provided that the valve device is able to be switched in a manner dependent on a pressure in the buffer container which is assigned to the fuel gas supply point. Here, in particular, the fluidic connection of the fuel gas supply point is always switched between one of the supply paths and the other supply path when the pressure level in the buffer container reaches or drops below a predetermined switching pressure level. In this case, the predetermined switching pressure level is preferably slightly above the first pressure level, which is not to be dropped below at the fuel gas supply point. For the purpose of switching the switching states of the other supply path during the fluidic connection of the one supply path to the fuel gas supply point, a prediction concerning the profile of the pressure in the third buffer container is preferably used. In particular, the other supply path is preferably blocked in such good time that a sufficiently high fuel gas pressure is able to be built up therein by way of the heat exchanger in sufficient time prior to the switchover of the fluidic connection to the other supply path. A time derivative of said pressure is preferably used for the prediction of the pressure in the third buffer container.

According to a refinement of the invention, it is provided that the fuel gas supply device is set up for activating the heat exchanger of a supply path when the supply path is blocked, and for deactivating the heat exchanger of the supply path otherwise, that is to say in all other switching states or operating states of the supply path or of the valve device. This preferably applies to each heat exchanger of each supply path of the fuel gas supply device. This configuration is particularly economical since the heat exchangers are activated only when liquid fuel gas is actually to be evaporated in the supply paths. It is furthermore advantageous if the heat exchangers are deactivated when the corresponding supply path is fluidically connected to the first storage volume of the fuel gas reservoir, in order that no redundant heat is introduced into the cryogenic fuel gas reservoir. Furthermore, a pressure by way of evaporation of the fuel gas, which pressure arises necessarily by way of an activated heat exchanger in the supply path, would impede or at least delay flowing-in of liquid fuel gas from the fuel gas reservoir.

The heat exchangers are therefore preferably formed such that they are able to be switched, wherein they are able to be switched on when liquid fuel gas is to be evaporated in the heat exchangers, and wherein they are otherwise able to be switched off.

According to a refinement of the invention, it is provided that at least one cooling device is arranged in the third fluidic connections. By means of such a cooling device, it is possible for the gaseous fuel gas, which has been relieved of pressure toward the pressure cushion, to be cooled in order to reduce or prevent additional introduction of heat into the fuel gas reservoir. Specifically, when exiting the supply paths, the gaseous fuel gas which is to be returned to the pressure cushion is warmer than the temperature level of the cryogenic fuel gas reservoir despite the cooling effect due to the expansion associated with the relief of pressure.

Particularly preferably, the third fluid paths assigned to the supply paths are merged into a common line section which connects them to the second storage volume, wherein a cooling device may be provided in the common line section in a particularly economic manner.

The object is finally also achieved by providing an internal combustion engine which has a fuel gas supply device according to one of the exemplary embodiments described before. Here, the advantages that have already been discussed in conjunction with the fuel gas supply device are achieved in conjunction with the internal combustion engine.

An engine block of the internal combustion engine is preferably connected to the fuel gas supply point of the fuel gas supply device. In particular, it is possible for a gas regulating section to be arranged between the fuel gas supply point and the engine block.

The internal combustion engine is preferably in the form of a reciprocating-piston engine. It is possible for the internal combustion engine to be set up for driving a passenger motor vehicle, a heavy goods motor vehicle or a utility vehicle. In a preferred exemplary embodiment, the internal combustion engine serves for driving in particular heavy land vehicles or watercraft, for example mining vehicles and trains, wherein the internal combustion engine is used in a locomotive or in a power car, or ships. Use of the internal combustion engine for driving a vehicle used for defense purposes, for example a tank, is also possible. An exemplary embodiment of the internal combustion engine is preferably also used in a static situation, for example for static energy supply for emergency-power operation, continuous-load operation or peak-load operation, wherein the internal combustion engine in this case preferably drives a generator. A static use of the internal combustion engine for driving auxiliary assemblies, for example fire-extinguishing pumps on drilling platforms, is also possible. A use of the internal combustion engine in the field of the conveyance of fossil resources and in particular fuels, for example oil and/or gas is possible. A use of the internal combustion engine in the industrial sector or in the construction sector, for example in a construction or building machine, for example in a crane or in a digger, is also possible. The internal combustion engine is preferably in the form of a diesel engine, a gasoline engine, a gas engine for operation with natural gas, biogas, special gas or some other suitable gas. In particular if the internal combustion engine is in the form of a gas engine, it is suitable for use in a cogeneration plant for static energy generation.

The invention is discussed in more detail below on the basis of the drawing, in which:

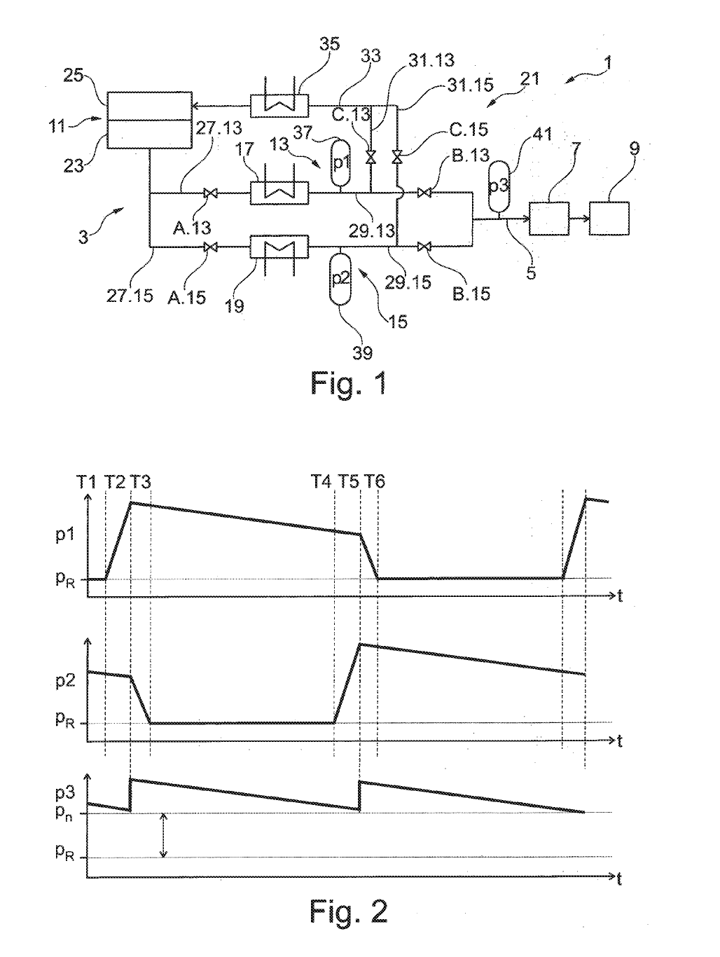

FIG. 1 shows a schematic illustration of an exemplary embodiment of an internal combustion engine having a fuel gas supply device, and

FIG. 2 shows a schematic, diagrammatic illustration of the operating principle for the fuel gas supply device.

FIG. 1 shows a schematic illustration of an internal combustion engine 1 having a fuel gas supply device 3 which is set up for providing a fuel gas to a fuel gas supply point 5 above a first pressure level. Connected to the fuel gas supply point 5 is a gas regulating section 7 to which, in turn, an engine block 9 is connected. Fuel gas provided by the fuel gas supply device 3 can be supplied to the engine block 9 via the gas regulating section 7. Here, the fuel gas is provided by way of the fuel gas supply device 3 for the gas regulating section 7 to the fuel gas supply point 5 at a pressure above the first pressure level, wherein the gas regulating section 7 serves for reducing the pressure, in a regulated manner, to a predetermined inlet pressure for the engine block 9.

The combustive force supply device 3 has a fuel gas reservoir 11 which is set up for storing liquid fuel gas, in particular for storing cryogenic, liquid fuel gas, in particular liquefied natural gas (LNG).

The fuel gas reservoir 11 is fluidically connected to a first supply path 13 and to a second supply path 15. The first supply path 13 has a first heat exchanger 17, and the second supply path 15 has a second heat exchanger 19. The heat exchangers 17, 19 are set up for evaporating liquid fuel gas.

There is provided a valve device 21 which is set up to alternately connect the first supply path 13 to the fuel gas supply point 5, and at the same time block the second supply path 15 or connect it to the fuel gas reservoir 11, and connect the second supply path 15 to the fuel gas supply point 5, and at the same time block the first supply path 13 or connect it to the fuel gas reservoir 11.

The fuel gas reservoir 11 has a first storage volume 23 for liquid fuel gas, and has a second storage volume 25 for gaseous fuel gas in particular as a pressure cushion for the first storage volume 23. In the fuel gas reservoir 11, the first storage volume 23 and the second storage volume 25 are preferably separated only by the phase boundary between the liquid fuel gas (liquid phase) and the gaseous fuel gas (gas phase).

The valve device 21 is set up such that, when one of the supply paths 13, 15 is connected to the fuel gas supply path 5, the other supply path 15, 13 is connected by the device to the second storage volume 25, then connected by the device to the first storage volume 23, and subsequently blocked by the device.

For this purpose, the valve device 21 has a first switching valve in each supply path, specifically a first switching valve A.13 in the first supply path 13 and a first switching valve A.15 in the second supply path 15. The first switching valves A.13, A.15 are each arranged in first fluid paths 27.13, 27.15 which are assigned to the supply paths 13, 15 and which each connect the first storage volume 23 to in each case one inlet of the heat exchanger 17, 19.

Furthermore, the valve device 21 has a second switching valve B.13, B.15 in each of the supply paths 13, 15, wherein these two switching valves B.13, B.15 are each arranged in second fluid paths 29.13, 29.15 which each connect an outlet of the heat exchangers 17, 19 to the fuel gas supply point 5.

The valve device 21 furthermore has for each of the supply paths 13, 15 a third switching valve C.13, C.15 which is arranged in each case in a third fluid path 31.13, 31.15, wherein the third fluid paths 31.13, 31.15 extend in each case to the second storage volume 25 from in each case one mouth into the second fluid paths 29.13, 29.15. In this case, the third fluid paths 31.13, 31.15 open into the second fluid paths 29.13, 29.15 in each case downstream of the outlets of the heat exchangers 17, 19 and upstream of the second switching valves B.13, B.15. The third fluid paths 31.13, 31.15 are merged into a common line section 33 through which they run together, wherein the common line section 33 opens into the second storage volume 25. There is arranged in the common line section 33 a cooling device 35 for cooling the fuel gas flowing through the common line section 33.

The first supply path 13 is assigned a first buffer container 37 in which a first pressure p1 prevails. The second supply path 15 is assigned a second buffer container 39 in which a second pressure p2 prevails. The buffer containers 37, 39 are arranged in the supply paths 13, 15 in each case downstream of the outlets of the heat exchangers 17, 19 and preferably upstream of the mouths of the third fluid paths 31.13, 31.15.

The fuel gas supply point 5 is assigned a third buffer container 41 in which a third pressure p3 prevails.

The pressures p1, p2, p3 vary with respect to time. Preferably, at least the third buffer container 41 is assigned a pressure sensor, which monitors the pressure in the third buffer container 41. It is additionally possible that at least one of the first and second buffer containers 37, 39, particularly preferably both buffer containers 37, 39, is in each case assigned a pressure sensor.

The valve device 21 is preferably switched in a manner dependent on the pressure p3 in the third buffer container 41, wherein, in particular, a prediction about the later development of the pressure p3 is factored into the switching behavior of the valve device 21.

The valve device 21 preferably has a control device (not illustrated) which is operatively connected both to the pressure sensor and to the switching valves such that the switching valves are able to be switched, by means of the control device, in a manner dependent on the pressure detected by the pressure sensor.

FIG. 2 shows a diagrammatic operating principle of the combustive force supply device 3. In this case, the pressures p1, p2 and p3 are plotted against time t here in three diagrams illustrated one below the other.

During a time interval denoted by T1, the valve device 21 is in a first switching state in which, in the first supply path 13, the first switching valve A.13 is open, the second switching valve B.13 is closed, and the third switching valve C.13 is closed. In the second supply path, the first switching valve A.15 is closed, the second switching valve B.15 is open, and the third switching valve C.15 is closed. In this case, liquid fuel gas flows from the first storage volume 23 into the first heat exchanger 17, and at the same time the fuel gas supply point 5 and thus also the gas regulating section 7 are supplied with gaseous fuel gas from the second supply path 15. The first pressure p1 is in this case at the level of the pressure p in the fuel gas reservoir 11, and so liquid fuel gas is able to flow in in particular by way of the action of gravity. The pressures p2, p3 in the second supply path 15 and at the fuel gas supply point 5 are identical and decrease over time t because fuel gas is discharged into the gas regulating section 7. In this case, a prediction as to when the pressure p3 is expected to reach a first, predetermined pressure level pₙ is preferably made on the basis of the rate at which the pressures p2, p3—in particular the pressure p3—decrease over time t. The valve device 21 is switched into a second switching state, which prevails during a second time interval T2, in good time beforehand.

In said second switching state, all switching valves A.13, B.13, C.13 of the first supply path 13 are closed, and, in the second supply path, again the second switching valve B.15 only is open, and all the other switching valves are closed. The fuel gas supply point 5 and thus the gas regulating section 7 therefore continue to be provided with a supply from the second supply path 15, this also being recognizable from the constantly decreasing pressures p2, p3.

The first heat exchanger 17 is activated in the first supply path, as a result of which liquid fuel gas is evaporated and a build-up of pressure occurs.

Shortly before the third pressure p3 reaches the first pressure level pₙ, the valve device 21 is switched into a third switching state T3. In this third switching state, in the first supply path 13, the first switching valve A.13 is closed, the second switching valve B.13 is open, and the third switching valve C.13 is closed. In the second supply path, the first switching valve A.15 and the second switching valve B.15 are closed, and the third switching valve C.15 is open. The fuel gas supply point 5 is now fed from the first supply path, which is why the pressure p3 suddenly increases to the pressure level of the first pressure p1 when switching into the third switching state T3, with both pressures then decreasing together and synchronously due to the supply of fuel gas to the gas regulating section 7. By contrast, the second supply path 15 is relieved of pressure toward the second storage volume 25 via the third fluid path 31.15 and the third switching valve C.15 such that the pressure here decreases to the pressure level of the fuel gas reservoir 11 p_{R}.

Once said pressure level p_{R} is reached, the valve device 21 is switched into a fourth switching state T4. In said state, in the first supply path 13, again the first switching valve A.13 is closed, the second switching valve B.13 is open, and the third switching valve C.13 is closed, and so the fuel gas supply point 5 continues to be provided with a supply from the first supply path 13. In the second supply path 15, the first switching valve A.15 is now open, while the second switching valve B.15 and the third switching valve C.15 are closed. Thus, liquid fuel gas flows from the fuel gas reservoir 11, specifically from the first storage volume 23, into the second heat exchanger 19, wherein this is possible in particular by way of the action of gravity because the fuel gas reservoir 11 and the second supply path 15 have the same pressure level p_{R}.

The valve device 21 is switched into a fifth switching state T5, again in good time, before the third pressure p3 reaches the predetermined first pressure level pₙ. In said fifth switching state, in the first supply path 13, the first switching valve A.13 is closed, the second switching valve B.13 is open, and the third switching valve C.13 is closed, and so the fuel gas supply point 5 continues to be provided with a supply from the first supply path 13. In the second supply path 15, all switching valves A.15, B.15, C.15 are now closed, and the second heat exchanger 19 is activated, with the result that a build-up of pressure occurs in the second supply path 15.

Shortly before the pressure p3 reaches the predetermined, first pressure level pₙ, the valve device 21 is switched into a sixth switching state T6. In said state, in the first supply path 13, the first switching valve A.13 and the second switching valve B.13 are closed, and the third switching valve C.13 is open. The first supply path 13 is therefore now relieved of pressure toward the pressure cushion 25 via the third fluid path 31.13 and the third switching valve C.13, as a result of which the pressure decreases to the pressure level p_{R} of the fuel gas reservoir 11. At the same time, the fuel gas supply point 5 is again fed from the second supply path 15 in which the first switching valve A.15 is closed, the second switching valve B.15 is open, and the third switching valve C.15 is closed.

The first switching state T1 then follows the sixth switching state T6 again, and a cyclic sequence of the six switching states described here is the overall result.

In this way, it is possible to keep the pressure p3 in the fuel gas supply point 5, and in particular in the buffer container 41 assigned thereto, above the first, predetermined pressure level pₙ, and in particular above the pressure level p_{R} of the fuel gas reservoir 11, at all times.

This is possible without a pump, with the pressure increase beyond the pressure level p_{R} of the fuel gas reservoir resulting rather as a consequence exclusively of the alternate switching of the supply paths 13, 15 and the supply of thermal energy in the heat exchangers 17, 19.

It is thus possible to keep the fuel gas reservoir 11 at a pressure level p_{R} which is lower than that which is necessary for the supply of fuel gas to a consumer, here the gas regulating section 7 or the engine block 9.

Thus, overall, by means of the fuel gas supply device 3 and the internal combustion engine 1, the result is reduced costs for the fuel gas reservoir 11 and a reduction in the weight of the fuel gas reservoir 11. It is possible to dispense with a cryopump, and protection against a pressure drop in the case of sloshing in a tank is afforded, and so here the proposed fuel gas supply device 3 is particularly suitable for marine applications.

1-9. (canceled)

10. A fuel gas supply device for providing a fuel gas to a fuel gas supply point, comprising:
a first supply path;
a second supply path;
a fuel gas reservoir set up for storing liquid fuel gas, wherein the fuel gas reservoir is fluidically connected to the first supply path and to the second supply path;
a first heat exchanger arranged in the first supply path to evaporate liquid fuel gas;
a second heat exchanger arranged in the second supply path to evaporate liquid fuel gas; and
a valve device operatively arranged to alternately
a) connect the first supply path to the fuel gas supply point, and simultaneously block the second supply path or connect it to the fuel gas reservoir, and
b) connect the second supply path to the fuel gas supply point, and simultaneously block the first supply path or connect it to the fuel gas reservoir.

11. The fuel gas supply device according to claim 10, wherein the fuel gas reservoir has a first storage volume for liquid fuel gas, and has a second storage volume for gaseous fuel gas as a pressure cushion for the first storage volume, wherein the valve device is configured so that, when one of the supply paths is connected to the fuel gas supply point, the other supply path:
a) is connectable to the second storage volume,
b) is connectable to the first storage volume, and
c) is blocked.

12. The fuel gas supply device according to claim 10, wherein the valve device includes for each supply path a first switching valve in a first fluidic connection between the first storage volume and the heat exchanger, and a second switching valve in a second fluidic connection between the heat exchanger and the fuel gas supply point.

13. The fuel gas supply device according to claim 12, wherein the valve device includes for each supply path a third switching valve in a third supply path between the heat exchanger and the second storage volume.

14. The fuel gas supply device according to claim 10, wherein the fuel gas supply point, the first supply path and/or the second supply path is/are assigned a buffer container.

15. The fuel gas supply device according to claim 14, wherein the valve device is switchable dependent on a pressure in the buffer container assigned to the fuel gas supply point.

16. The fuel gas supply device according to claim 10, wherein the heat exchanger of a supply path is activated when the supply path is blocked, and the heat exchanger is otherwise deactivated.

17. The fuel gas supply device according to claim 13, wherein at least one cooling device is arranged in the third supply path.

18. An internal combustion engine, comprising a fuel gas supply device according to claim 10.
